(19) United States
(12) Patent Application Publication
(10) Pub. No.: US 2024/0141145 A1
(43) Pub. Date: May 2, 2024

(54) RUBBER MIXTURE COMPRISING BIOTECHNICALLY MODIFIED RUBBER PARTICLES

(71) Applicant: Vibracoustic SE, Darmstadt (DE)

(72) Inventors: Stefanie Deike, Bensheim (DE); Melanie Gräfen, Dortmund (DE); Marcel Diehl, Bischofsheim (DE)

(21) Appl. No.: 18/383,740

(22) Filed: Oct. 25, 2023

(30) Foreign Application Priority Data
Oct. 26, 2022 (DE) 10 2022 128 331.3

(51) Int. Cl. C08L 7/00; C08F 136/08; C08K 3/04; C08K 3/06; C08K 3/36; C08L 17/00

(52) U.S. Cl. CPC C08L 7/00; C08F 136/08; C08K 3/04; C08K 3/06; C08K 3/36; C08L 17/00; C08L 2203/20; C08L 2205/025; C08L 2205/18; C08L 2207/20

(57) ABSTRACT

A rubber mixture includes natural rubber, butadiene rubber, styrene-butadiene rubber, synthetic polyisoprene or ethylene-propylene-diene rubber or a blend of two or more types of rubber, filler, crosslinking system and recycled rubber particles. The recycled rubber particles may be biotechnologically modified. The addition of the modified rubber particles can improve the physical properties of rubber mixtures and the lifetime of engine mounts or bushings. The biotechnical processing of the vulcanized rubber and the use of the high-quality modified rubber particles in new mixtures can distinctly reduce the amount of waste and the amount of CO₂ emitted by virtue of the use of recyclate and can increase the proportion of recycled material in the product. The disclosure further provides for the use of rubber mixtures for industrial rubber products, such as engine mounts and bushings.

### CROSS-REFERENCE TO RELATED APPLICATIONS

This application claims priority to German Patent Application No. DE 10 2022 128 331.3, filed on Oct. 26, 2022, the contents of which is hereby incorporated by reference in its entirety.

### TECHNICAL FIELD

The invention provides a rubber mixture and associated processes, including a process for producing modified rubber particles.

### BACKGROUND

Every year, the rubber-processing industry, for process-related reasons, generates large tonnages of waste vulcanized rubber, which is treated as waste or processed to give low-value products. Since rubber has a high calorific value (3.3*10⁴ kJ/kg), a basic method of disposal, especially for tires, is controlled combustion together with coal as alternative fuel for energy recovery, for generation of steam, electrical energy, chemical pulp, paper, lime and steel. Even whole tires are used, particularly in the cement industry, where cement furnaces run at temperatures of more than 1200° C., which ensures complete combustion of all constituents. The combustion of the wastes leads to the release of relatively large amounts of carbon dioxide (CO₂) and removes the combusted volumes from the value cycle. Many tire manufacturers have announced that, from as early as 2030, they will use a defined proportion of recycled or biologically generated materials in tires and constantly increase this proportion. At present, these efforts relate to plastics in particular, but other materials such as rubber are not being ruled out and may in the future likewise make a major contribution to a circular value addition chain.

In the last few years, in the rubber industry too, the search for options for recycling of materials has been accelerated. One approach is the pyrolysis of used rubber and the use of the following resulting products: recovered carbon black, pyrolysis oil and the recovered steel. A further means of processing vulcanized rubber wastes for reuse is the devulcanization with the aim of extracting sulfur from the material. In these processes, the intention is to break the sulfur bridges without cleaving bonds within the polymer chain. Various methods are employed for this purpose. In addition to thermomechanical processing in the extruder, additives, ultrasound or supercritical CO₂ are also used as auxiliary for improvement of the devulcanization and reduction of polymer chain scission. However, the use of very high temperatures exceeding 150° C. up to 300° C. will not just cleave sulfur bridges but also polymer chains, which reduces the properties. The standard devulcanization methods are thus more downcycling than recycling.

US 2019/0382564 A1 describes a rubber mixture based on an elastomer, a filler, a crosslinking system and rubber granules. The rubber granules are obtained by recycling rubber material by grinding to particles having a defined particle size distribution.

The tire granules made from used tires or rubber wastes that are used in such applications are unmodified and frequently lead to reduced properties of the new rubber mixture.

### SUMMARY

Aspects and features of the invention are disclosed herein.

A rubber mixture in accordance aspects and teachings of the invention may comprise:
rubber selected from natural rubber (NR), butadiene rubber (BR), styrene-butadiene rubber (SBR), synthetic polyisoprene (IR) or ethylene-propylene-diene rubber (EPDM) or a blend of two or more types of rubber,
at least one filler,
at least one crosslinking system, and
recycled rubber particles.

The recycled rubber particles consist of ground, biotechnologically modified polyisoprene selected from natural rubber, synthetic polyisoprene or mixtures thereof. The recycled rubber particles have a functionalized surface having functional groups.

Rubber is understood to mean vulcanized natural or synthetic rubbers containing further ingredients as well as rubber. The rubber mixture of the invention includes natural rubber (NR), butadiene rubber (BR), styrene-butadiene rubber (SBR), synthetic polyisoprene, (IR) or ethylene-propylene-diene rubber (EPDM) or a mixture of two or more types of rubber. The rubber present in the rubber mixtures is preferably a mixture of natural rubber and synthetic polyisoprene.

The modified rubber particles may be enzyme-treated rubber particles based on vulcanized, carbon black-containing isoprene rubber.

### BRIEF DESCRIPTION OF THE DRAWINGS

Embodiments of the disclosure will now be described, by way of example, with reference to the accompanying drawings, wherein:

FIG. 1 generally illustrates a representation of a modified rubber particle in accordance with aspects and teachings of the present disclosure;

FIG. 2 generally illustrates an example of an elastomer bushing arranged in a test fixture; and

FIG. 3 generally shows the proportion of oligo-isoprenoids after the enzyme treatment as a function of the average particle diameter of the ground rubber.

### DETAILED DESCRIPTION

Embodiments of a rubber mixture may contain 15 to 75 phr, preferably min. 50 phr, of recycled rubber particles. Some embodiments of a rubber mixture may preferably contain 50 phr to 75 phr of recycled rubber particles.

The unit “phr” means parts by weight per hundred parts rubber. This means that, for every hundred parts raw rubber, X parts rubber particles or other components are additionally present. The proportion of rubber in the rubber particles is not considered to be raw rubber. The phr figures are always based on the composition prior to vulcanization.

Modified rubber particles for some embodiments may preferably have an average particle diameter of less than 700 μm, preferably of less than 500 μm, further preferably of less than 400 μm, and more preferably of less than 250 μm.

The modified rubber particles have a functionalized surface having functional groups. The functional groups of the modified rubber particles are preferably carbonyl groups, preferably terminal aldehyde groups and/or terminal ketone groups on the particle surface. The aldehyde groups and ketone groups are formed on enzymatic degradation of the polyisoprene and are thus carbonyl groups on the partly degraded polyisoprene.

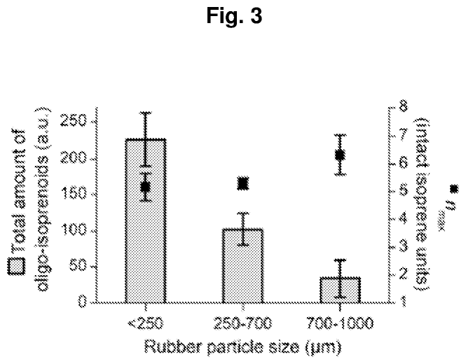

As well as the functionalized rubber particles having functional groups, the enzyme treatment of ground rubber also gives rise to functionalized oligomers. The number of these oligomers depends greatly on the particle size of the starting material and increases with decreasing size. FIG. 3 shows the proportion of oligo-isoprenoids after the enzyme treatment as a function of the average particle diameter of the ground rubber. In the case of smaller particles and hence greater surface area, greater functionalization takes place, which results in a higher number of oligo-isoprenoids. These functionalized oligomers, by virtue of their specific properties, may fulfill various functions on introduction into rubber mixtures. By virtue of the low molar masses, they act as processing auxiliaries and plasticizers, and because of the functionality are not as easily extractable as oils.

For example, liquid butadiene rubber showed advantages over TDAE (treated distillate aromatic extract) oil, since it migrated to a lesser degree and functionality causes better dispersion of the filler.

Moreover, the functionalized oligomers, by virtue of the combination of carbonyl functionality and isoprene structure, can act as mediators between the rubber chains and the modified particles.

As well as the rubber, the rubber mixture contains fillers, cross-linkers and other vulcanization auxiliaries. Suitable fillers are reinforcing fillers, for example carbon black, silica or mixtures thereof. The filler is particularly carbon black when a dark color of the rubber product is to be achieved. The filler is present in an amount of 5 to 200 phr, preferably of 10 to 150 phr. Suitable carbon blacks are ASTM-classified carbon blacks, for example N115, N220, N330, N550, N660, N772, N990, although other carbon blacks for rubber products are possible.

The mixture may contain silica or mixtures of different silicas.

The crosslinking system is preferably based on sulfur or a sulfur donor and a primary vulcanization accelerator. In addition, it is possible to use secondary accelerators and activators, for example zinc oxide and stearic acid. Sulfur is preferably present in an amount of 0.1 phr to 5 phr, more preferably of 0.5 to 3 phr.

In one embodiment, the rubber mixture additionally comprises one or more of the following additives selected from: plasticizer, resin, aging stabilizer and antiozonant wax.

In a preferred embodiment, the rubber mixture of the invention comprises:
100 phr natural rubber and/or synthetic polyisoprene,
15 phr to 75 phr modified rubber particles, preferably 50 to 75 phr,
0.1 phr to 5 phr sulfur,
5 phr to 200 phr carbon black, preferably 10 phr to 150 phr carbon black, and
1 phr to 50 phr additives, preferably 1 phr to 20 phr additives, for example plasticizers, aging stabilizers, antiozonant waxes, resins, and accelerators.

For production of the modified rubber particles, i.e. of the enzyme-treated rubber particles, rubber wastes composed of a mixture of natural rubber or synthetic polyisoprene or blends of natural rubber or polyisoprene with other rubbers, preferably BR or SBR, with carbon black, silica or other fillers, preferably rubber wastes from used tires or rubber wastes from other rubber products, are ground to particles. The rubber particles obtained by grinding have an average particle diameter of less than 700 μm, preferably of less than 500 μm, preferably of less than 400 μm, preferably of less than 250 μm. The rubber particles are first pretreated after grinding. For the pretreatment, the rubber particles are extracted with organic solvent, preferably with ethyl acetate, acetone, chloroform, n-pentane, cyclohexane, hexane, dichloromethane, toluene or mixtures thereof, more preferably acetone, cyclohexane, chloroform or a mixture of acetone with cyclohexane. The pretreated rubber particles are admixed with an enzyme selected from Lcp (latex clearing protein), RoxA (rubber oxygenase), RoxB (rubber oxygenase) and mixtures thereof, preferably Lcp1_{VH2}, for degradation of the rubber mixture to oligo-isoprenes and for modification of the surface.

LCPs (latex clearing proteins), RoxA and RoxB are rubber oxygenases that catalyze the addition of molecular oxygen onto the cis double bonds, as a result of which oxidative cleavage takes place, which results in the formation of aldehyde and ketone groups on the rubber chain. As a result of the use of rubber particles, oxidative cleavage takes place at the surface, where it generates functional groups.

Preference is given to using Lcp_{K30}, RoxA_{XSp}, RoxB_{XSp}, more preferably Lcp1_{VH2}.

The enzymes are produced by a fed-batch fermentation process, for example in E. coli C41.

The treatment of the rubber particles can take place in vitro in an incubation shaker with a buffer solution, for example in a TRIS/HCl buffer with pH 7. The enzyme can be added by a single addition or in multiple steps, for example daily over a period of several days, preferably over 5 days.

Modified rubber particles may be produced by the following steps:
providing rubber wastes composed of a mixture of natural rubber and synthetic polyisoprene or of natural rubber or of synthetic polyisoprene, each comprising carbon black, silica or other fillers,
grinding the rubber wastes to particles having an average particle diameter of less than 700 μm, preferably of less than 500 μm, further preferably less than 400 μm and more preferably of less than 250 μm,
pretreating the rubber particles with an organic solvent in an extraction step, and
treating the rubber particles with an enzyme selected from Lcp, RoxA, RoxB and mixtures thereof.

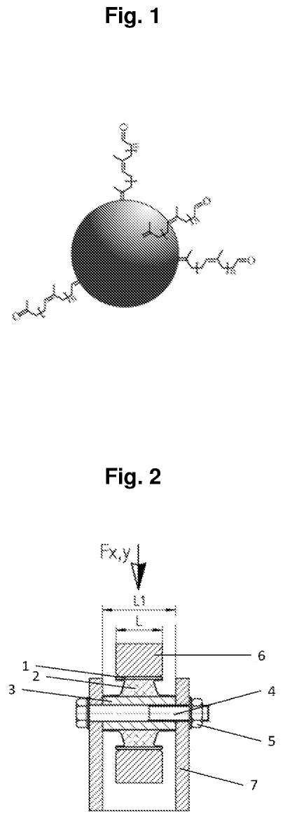

This production process for the modified rubber particles avoids cleavage of sulfur bridges, and selective cleavage of the rubber chains and functionalization of the surface of the rubber particles with carbonyl groups are achieved. FIG. 1 shows, by way of example, a modified rubber particle with carbonyl groups and polyisoprene radical groups on the surface. The increased chain flexibility after cleavage and the polar functionalization allow the resultant material to be integrated as active filler into new rubber mixtures, with the properties of the resultant material being very similar to the original, whereas devulcanized material leads to a distinct deterioration in the properties. In particular, the high temperatures required for successful devulcanization damage the material irreversibly.

The rubber particles are thus modified using enzymes, with preservation of the sulfur network of the recycled rubber. The resulting rubber particles are functionalized on the surface, as a result of which they show improved binding to the rubber matrix. In this way, it is possible to add more than 15 phr functionalized rubber particles to a new rubber mixture with the same or improved properties, whereas, in the case of unmodified particles, a maximum of less than 10 phr can be added.

The addition of the modified rubber particles improves the physical properties of rubber mixtures and the lifetime of engine mounts or bushings. The use of enzyme-treated rubber granules with a functionalized surface result in better binding to the rubber matrix. High-quality rubber wastes in particular that form directly in the rubber production can be introduced into the circular economy and no longer have to be incinerated.

The invention further provides for the use of the rubber mixtures of the invention for technical rubber products, preferably for engine mounts and bushings.

The rubber mixture of the invention comprising biotechnologically modified rubber particles can be used for components in the automotive sector. The newly developed materials should be used in engine mounts or bushings. However, other typical applications for natural rubber mixtures are also conceivable.

The biotechnical processing of the vulcanized rubber and the use of the high-quality modified rubber particles in new mixtures distinctly reduces the amount of waste and the amount of CO₂ emitted through the use of recyclate, and increases the proportion of recycling in the product. Using the example of tires, which have been considered most frequently to date because of their volume, it has been shown that physical utilization with respect to incineration in the cement industry leads to a saving of 2.5 tonnes of CO₂ per tonne of tires. For vulcanized rubber mixtures, therefore, the order of magnitude can be considered to be similar.

The modified rubber particles may be mixed in as recyclate in high proportions of 50 phr (parts per hundred rubber).

### EXAMPLES

### Example I Production of the Modified Particles

For production of modified particles, the rubber granules were treated together in an incubation shaker at 30° C. with Lcp1_{VH2} and a buffer solution (TRIS/HCl buffer (0.2 M, pH 7)) in a glass vessel for 5 days. For this purpose, 500 mg of enzyme was used per gram of rubber granules and the vessel was shaken at 90 rpm.

### Example II Production of the Rubber Mixture

Rubber mixtures with the compositions specified in table 1 were produced.

TABLE 1
Formulations of the rubber mixture prior to vulcanization, with
6PPD = N-(1,3-dimethylbutyl)-N′-phenyl-p-phenylenediamine,
CBS = accelerator based on N-cyclohexyl-2-benzothiazylsulfenamide;
CBS and sulfur together form the crosslinking system

| | Rubber | Comparative |
|---|---|---|
| | mixture M1 | mixture V1 |
| Natural rubber (NR) | 100 | 100 |
| Modified rubber particles | 50 | — |
| from example I | | |
| Carbon black (ASTM N550) | 80 | 80 |
| Zinc oxide | 5 | 5 |
| Stearic acid | 2 | 2 |
| Aging stabilizer* (6PPD) | 2 | 2 |
| Accelerator* (CBS) | 2 | 2 |
| Sulfur | 2 | 2 |

The abovementioned components were mixed in two stages in an internal mixer. In the first stage, all components except the crosslinking system were mixed until a maximum temperature of 110° C. to 190° C. was attained. In the second stage, the crosslinking system was added and mixed at temperatures below 110° C. for a maximum of 5 minutes.

The resultant mixtures were vulcanized at 150° C. to 15 minutes in order to obtain 2 mm sheets and elastomer bushings according to FIG. 2.

FIG. 2 shows an example of an elastomer bushing with an outer sleeve 1, an elastomer body 2 and an inner sleeve 3, which is arranged in a test fixture 6,7. Here, Fx,y denotes the force applied to the test fixture 6. The testing fixture 6 connects the moving part of the testing machine to the outer sleeve 1. It can further be seen that the elastomer bushing is fixed to the rigid part 7 of the testing fixture by means of bolts 5, particularly the inner core 4 of the bushing is clamped to the rigid part 7 by the bolt 5.

Determination of the Material Properties

The rubber mixtures produced in example II were examined for their mechanical properties according to DIN 53504. The mixtures obtained were also used to produce bearing bushes as specimen components which, according to FIG. 2, were subjected to cyclical radial stress at two different amplitudes in a sustained test at 23° C. The properties measured and the lifetime testing results on a reference mixture and a mixture with 50 phr modified rubber particles are listed in table 2.

The properties of the rubber mixture according to example M1 were distinctly improved compared to a reference mixture V1 without elastomer particles, as was the lifetime of elastomer bushes produced with said mixture.

TABLE 2
Mechanical properties and results of the lifetime
testing of the vulcanized mixtures

Example

| | | M1 | V1 |
|---|---|---|---|
| Elongation at | [%] | 331 | 300 |
| break | | | |
| Tensile | [N/mm²] | 18.9 | 16.9 |
| strength | | | |
| Number of | | 842 500 | 272 500 |
| changes of load | | | |
| (amplitude | | | |
| 2 mm) | | | |
| Number of | | 2 200 000 | 1 610 000 |
| changes of load | | | |
| (amplitude | | | |
| 1.75 mm) | | | |

It was thus shown that the addition of functionalized elastomer waste not only leads to mixtures having the same properties, but can actually distinctly improve these properties.

The invention is not limited to one of the embodiments described above, but is modifiable in various ways.

All features and advantages that are apparent from the claims, the description and the drawing, including construction details, spatial arrangements and process steps, may be essential to the invention either on their own or in a wide variety of different combinations.

1. A rubber mixture comprising:
rubber selected from natural rubber, butadiene rubber, styrene-butadiene rubber, synthetic polyisoprene or ethylene-propylene-diene rubber or a blend of two or more types of rubber,
at least one filler,
at least one crosslinking system, and
recycled rubber particles,
wherein the recycled rubber particles consist of biotechnologically modified rubber mixtures and have a functionalized surface with functional groups.

2. The rubber mixture as claimed in claim 1, wherein the biotechnologically modified rubber particles are enzyme-treated rubber particles based on vulcanized isoprene rubber.

3. The rubber mixture as claimed in claim 1, wherein the rubber mixture contains 15 to 75 phr of biotechnologically modified rubber particles.

4. The rubber mixture as claimed in claim 1 claims, wherein the rubber mixture contains a minimum of 50 phr of biotechnologically modified rubber particles.

5. The rubber mixture as claimed in claim 1, wherein the recycled rubber particles have an average particle diameter of less than 700 μm.

6. The rubber mixture as claimed in claim 1, wherein the recycled rubber particles have an average particle diameter of less than 500 μm.

7. The rubber mixture as claimed in claim 1, wherein the recycled rubber particles have an average particle diameter of less than 400 μm.

8. The rubber mixture as claimed in claim 1, wherein the recycled rubber particles have an average particle diameter of less than 250 μm.

9. The rubber mixture as claimed in claim 1, wherein the modified rubber mixtures have, as functional groups, carbonyl groups on a particle surface.

10. The rubber mixture as claimed in claim 9, wherein the carbonyl groups are terminal aldehyde groups and/or terminal ketone groups.

11. The rubber mixture as claimed in claim 1, wherein the rubber mixture comprises, as rubber, a mixture of natural rubber and synthetic polyisoprene.

12. The rubber mixture as claimed in claim 1, wherein the filler is carbon black or silica.

13. The rubber mixture as claimed in claim 1, wherein the crosslinking system is sulfur.

14. The rubber mixture as claimed in claim 13, wherein the sulfur is present in an amount of 0.1 phr to 5 phr.

15. The rubber mixture as claimed in claim 1, wherein the rubber mixture additionally comprises one or more of the following components: plasticizer, resin, aging stabilizer and accelerator.

16. The rubber mixture as claimed in claim 1, wherein the rubber mixture comprises:

| | |
|---|---|
| 100 phr | natural rubber and/or synthetic polyisoprene, |
| 15 phr to 75 phr | modified rubber particles, |
| 0.1 phr to 5 phr | sulfur, |
| 5 phr to 200 phr | carbon black, preferably 10 phr to 150 phr carbon |
| | black, and |
| 1 phr to 50 phr | further additives. |

17. The rubber mixture as claimed in claim 1, wherein the modified rubber particles are produced in a process comprising:
a) providing rubber wastes composed of a mixture of natural rubber and synthetic polyisoprene or of natural rubber or of synthetic polyisoprene, each comprising carbon black, silica or other fillers,
b) grinding the rubber wastes to particles having an average particle diameter of less than 700 μm, of less than 500 μm, less than 400 μm, or less than 250 μm,
c) pretreating the rubber particles with an organic solvent in an extraction step, and
d) treating the rubber particles with an enzyme selected from Lcp, RoxA, RoxB, and mixtures thereof.

18. A process for producing modified rubber particles as claimed in claim 1, comprising:
a) providing rubber wastes composed of a mixture of natural rubber and synthetic polyisoprene or of natural rubber or of synthetic polyisoprene, each comprising carbon black, silica or other fillers,
b) grinding the rubber wastes to particles having an average particle diameter of less than 700 μm, less than 500 μm, less than 400 μm, and less than 250 μm,
c) pretreating the rubber particles with an organic solvent in an extraction step, and
d) treating the rubber particles with an enzyme selected from Lcp, RoxA, RoxB, and mixtures thereof.

19. The use of rubber mixtures as claimed in claim 1 for industrial rubber products.

20. The use of rubber mixtures as claimed in claim 1 for engine mounts and bushings.
